(19) United States
(12) Patent Application Publication
(10) Pub. No.: US 2018/0003287 A1
(43) Pub. Date: Jan. 4, 2018

(54) AUTOMATIC TRANSMISSION

(71) Applicant: AISIN AW CO., LTD., Anjo-shi, Aichi-ken (JP)

(72) Inventors: Toshihiko AOKI, Anjo (JP); Mitsugi YAMASHITA, Anjo (JP); Joji MORIYAMA, Kariya (JP); Yukio SUGIURA, Hekinan (JP); Hi AN, Nishio (JP)

(73) Assignee: AISIN AW CO., LTD., Anjo-shi, Aichi-ken (JP)

(21) Appl. No.: 15/537,687

(22) PCT Filed: Jan. 5, 2016
(86) PCT No.: PCT/JP2016/050121

§ 371 Date: Jun. 19, 2017

(30) Foreign Application Priority Data
Jan. 30, 2015 (JP) 2015-017731

(51) Int. Cl. F16H 57/04; F16H 59/22; F16H 59/70; F16H 59/24; F16H 61/02; F16H 59/72

(52) U.S. Cl. CPC F16H 57/04; F16H 59/70; F16H 59/24; F16H 59/22; F16H 59/72; F16H 61/02

(57) ABSTRACT

An automatic transmission that includes a speed change mechanism including a gear mechanism that can attain a plurality of shift speeds, and a plurality of friction engagement elements that are selectively engaged to attain each shift speed in the gear mechanism; a hydraulic control device that can regulate engagement pressures to be supplied to hydraulic servos of the plurality of friction engagement elements and that can supply lubricating oil that lubricates the speed change mechanism; and a control unit that sends a command about the engagement pressures to the hydraulic control device to control engagement states of the plurality of friction engagement elements.

### BACKGROUND

This technique relates to automatic transmissions that are mounted on vehicles etc., and particularly to automatic transmissions that attain a plurality of shift speeds by selectively engaging a plurality of friction engagement elements.

Multi-stage automatic transmissions that are mounted on vehicles etc. are typically structured such that a speed change mechanism having a gear mechanism such as a planetary gear and friction engagement elements such as clutches and brakes are lubricated by lubricating oil that is supplied from a hydraulic control device. When the temperature of the lubricating oil is low, viscous resistance of the oil is high, which hinders improvement in fuel economy of vehicles. It is therefore desired to increase the oil temperature in the automatic transmission to an appropriate temperature as quickly as possible, namely it is desired to quickly warm up the automatic transmission, in the case where, e.g., a vehicle having been stopped for a long period of time is started.

As a solution, an automatic transmission is proposed in which, when a vehicle is started to move and the oil temperature in an automatic transmission is low, heat is generated by performing slip control of a friction engagement element that is engaged in shifting, whereby the temperature of lubricating oil is increased (see Japanese Patent Application Publication No. 2012-154427).

### SUMMARY

In Japanese Patent Application Publication No. 2012-154427, however, the friction engagement element is caused to slip only during shifting. This causes loss of a driving force from a driving source, hindering improvement in fuel economy.

An exemplary aspect of the present disclosure provides an automatic transmission that can be warmed up without hindering improvement in fuel economy.

An automatic transmission according to an exemplary aspect of the present disclosure includes: a speed change mechanism including a gear mechanism that can attain a plurality of shift speeds, and a plurality of friction engagement elements that are selectively engaged to attain each shift speed in the gear mechanism; a hydraulic control device that can regulate engagement pressures to be supplied to hydraulic servos of the plurality of friction engagement elements and that can supply lubricating oil that lubricates the speed change mechanism; and a control unit that sends a command about the engagement pressures to the hydraulic control device to control engagement states of the plurality of friction engagement elements. When a vehicle is in a non-driving state and a non-shifting state where the shift speed is maintained and an oil temperature is higher than a predetermined temperature, the control unit supplies an engagement pressure to a hydraulic servo of a friction engagement element being in an engaged state and maintaining the shift speed, and does not supply an oil pressure so as to disengage a different friction engagement element of the friction engagement elements, the different friction engagement element being different from the friction engagement element being in the engaged state. When the vehicle is in the non-driving state and the non-shifting state where the shift speed is maintained and the oil temperature is the predetermined temperature or less, the control unit supplies the engagement pressure to the hydraulic servo of the friction engagement element being in the engaged state and maintaining the shift speed, and supplies an oil pressure so that the different friction engagement element different from the friction engagement element being in the engaged state is in a slipping state.

According to the automatic transmission of the present disclosure, when the vehicle is in the non-driving state and the non-shifting state where the shift speed is maintained and the oil temperature is the predetermined temperature or less, the different friction engagement element that is different from the friction engagement element being engaged while the shift speed is maintained is caused to slip. The friction engagement element is therefore not caused to slip by the driving force of a driving source, but is caused to slip by the inertial force of the vehicle. Accordingly, fuel of the driving source need not be consumed for slipping, whereby warm-up can be performed while preventing improvement in fuel economy of the vehicle from being hindered.

### BRIEF DESCRIPTION OF THE DRAWINGS

FIG. 1 is a skeleton diagram showing an automatic transmission according to an embodiment of the present disclosure.

FIG. 2 is an engagement table of the automatic transmission.

FIG. 3 is a block diagram showing a control system of the automatic transmission.

FIG. 4 is a flowchart illustrating warm-up slip control.

FIG. 5 is a timing chart illustrating warm-up slip control according to a first embodiment.

FIG. 6 is a timing chart showing an example of engagement pressures in the warm-up slip control according to the first embodiment.

FIG. 7 is a timing chart illustrating warm-up slip control according to a second embodiment.

FIG. 8 is a timing chart showing an example of engagement pressures in the warm-up slip control according to the second embodiment.

FIG. 9 is a timing chart illustrating warm-up slip control according to a third embodiment.

FIG. 10 is a timing chart showing an example of engagement pressures in the warm-up slip control according to the third embodiment.

### DETAILED DESCRIPTION OF EMBODIMENTS

### First Embodiment

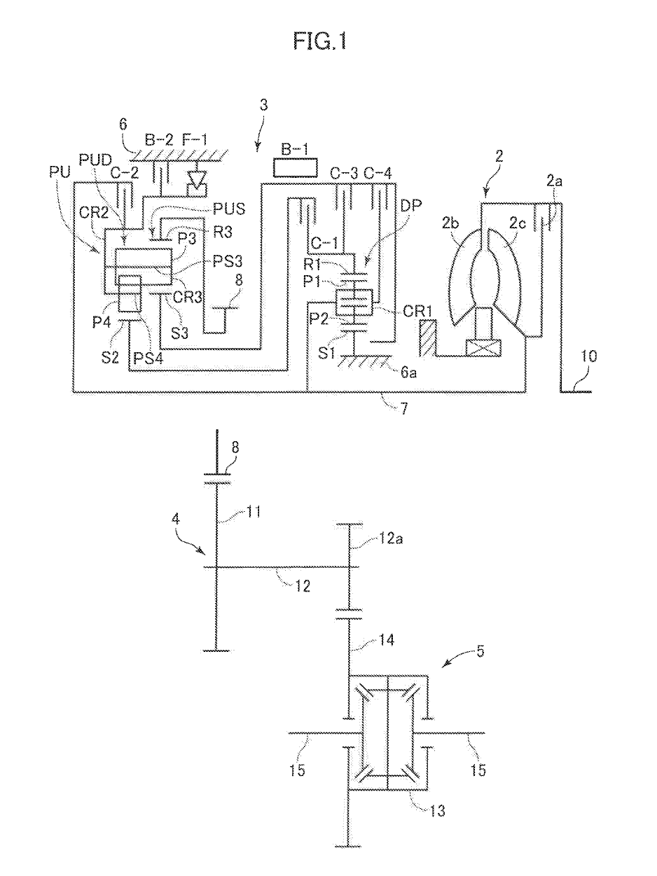

A first embodiment will be described below with reference to FIGS. 1 to 6.

The general configuration of an automatic transmission 1 according to the present embodiment will be described with reference to FIG. 1. The automatic transmission 1 is preferably mounted on vehicles in which an engine output shaft is placed transversely with respect to the direction in which the vehicle travels, such as, e.g., front-engine, front-wheel drive (FF) vehicles. Although the automatic transmission 1 that is mounted on FF vehicles is described in the present embodiment, the automatic transmission 1 may be an automatic transmission that is mounted on vehicles in which an engine output shaft is placed longitudinally with respect to the direction in which the vehicle travels, such as, e.g., front-engine, rear-wheel drive (FR) vehicles.

As shown in FIG. 1, the automatic transmission 1 includes a case 6 formed by a housing case and a transmission case, and has, on the front side of the case 6, an input member (a front cover and a centerpiece) 10 connected to an engine serving as a driving source, not shown. The automatic transmission 1 further includes a torque converter 2 having a lockup clutch 2a. An automatic speed change mechanism (speed change mechanism) 3, a countershaft unit 4, and a differential unit 5 are placed in the case 6.

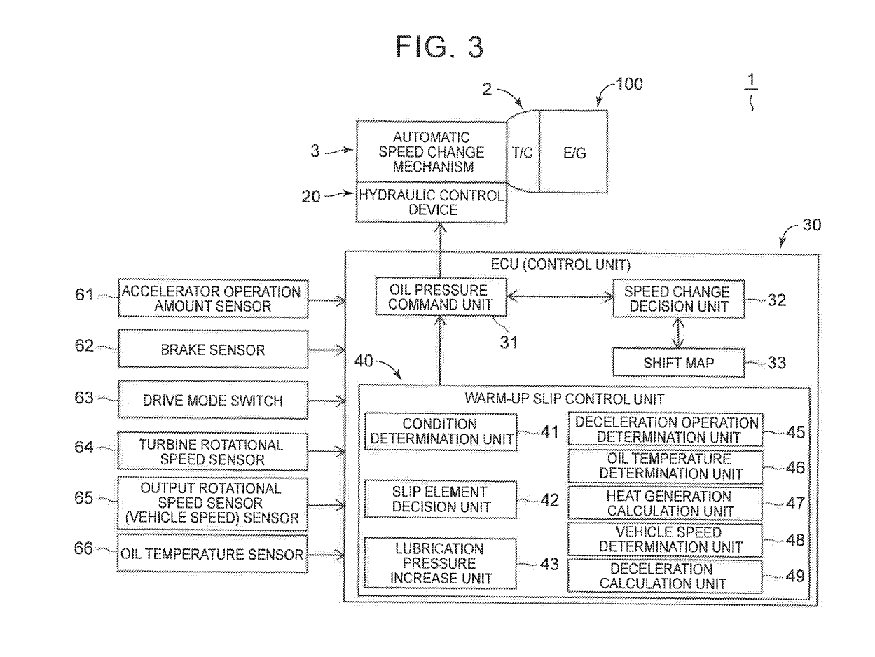

The torque converter 2 has a pump impeller 2b connected to the input member 10, and a turbine runner 2c to which rotation of the pump impeller 2b is transmitted via working fluid. The turbine runner 2c is connected to an input shaft 7 of the automatic speed change mechanism 3 which is disposed coaxially with the input member 10. The torque converter 2 includes the lockup clutch 2a. When the lockup clutch 2a is engaged by hydraulic control of a hydraulic control device 20 (see FIG. 3), rotation of the input member 10 of the automatic transmission 1 is directly transmitted to the input shaft 7 of the automatic speed change mechanism 3.

The automatic speed change mechanism 3 includes, on the input shaft 7, a planetary gear (gear mechanism) DP and a planetary gear unit (gear mechanism) PU. The planetary gear DP is what is called a double-pinion planetary gear that includes a sun gear S1, a carrier CR1, and a ring gear R1 and that has, on the carrier CR1, a pinion P2 meshing with the sun gear S1 and a pinion P1 meshing with the ring gear R1 such that the pinions P1, P2 mesh with each other.

The planetary gear unit PU is structured such that two planetary gears, namely a single-pinion planetary gear PUS and a double-pinion planetary gear PUD, are coupled to each other. The single-pinion planetary gear PUS includes a sun gear S3, a carrier CR3, and a ring gear R3, and the double-pinion planetary gear PUD includes a sun gear S2 and a carrier CR2. The single-pinion planetary gear PUS and the double-pinion planetary gear PUD further have a common pinion, which is a long pinion P3. The planetary gear unit PU further has a short pinion P4 included in the double-pinion planetary gear PUD and meshing with the long pinion P3. The single-pinion planetary gear PUS and the double-pinion planetary gear PUD include the carriers CR2, CR3 that support a pinion shaft PS3 rotatably supporting the long pinion P3 and a pinion shaft PS4 rotatably supporting the short pinion P4.

Although the carriers CR2, CR3 are described as the carrier CR2 of the double-pinion planetary gear PUD and the carrier CR3 of the single-pinion planetary gear PUS, the carriers CR2, CR3 are a single carrier that has the common long pinion P3 and that makes the same rotation. That is, the planetary gear unit PU is what is called a Ravigneaux type planetary gear that has, as four rotary elements, the sun gear S2 serving as a sun gear of the double-pinion planetary gear PUD, the sun gear S3 serving as a sun gear of the single-pinion planetary gear PUS, the carriers CR2, CR3, and the ring gear R3.

The sun gear S1 of the planetary gear DP is firmly fixed to the case 6. The carrier CR1 makes the same rotation (hereinafter referred to as the “input rotation”) as that of the input shaft 7, and is connected to a fourth clutch C-4. The ring gear R1 makes decelerated rotation, namely rotation decelerated from the input rotation, by the sun gear S1 that is held stationary and the carrier CR1 that makes the input rotation. The ring gear R1 is connected to a first clutch C-1 and a third clutch C-3.

The sun gear S3 of the planetary gear unit PU is connected to a first brake B-1, which is, e.g., a band brake, so that the sun gear S3 can be held stationary with respect to the case 6. The sun gear S3 of the planetary gear unit PU is also connected to the fourth clutch C-4 and the third clutch C-3, so that the sun gear S3 can receive the input rotation of the carrier CR1 via the fourth clutch C-4 and can receive the decelerated rotation of the ring gear R1 via the third clutch C-3. The sun gear S2 is connected to the first clutch C-1, so that the sun gear S2 can receive the decelerated rotation of the ring gear R1.

The carrier CR2 (CR3) is connected to a second clutch C-2 that receives the rotation of the input shaft 7, so that the carrier CR2 (CR3) can receive the input rotation via the second clutch C-2. The carrier CR2 (CR3) is also connected to a one-way clutch F-1 and a second brake B-2, so that rotation of the carrier CR2 (CR3) in one direction relative to the case 6 is restricted via the one-way clutch F-1 and the carrier CR2 (CR3) can be held stationary via the second brake B-2. The ring gear R3 is connected to a counter gear 8 that is rotatably supported by a center support member, not shown, fixed to the case 6.

A large diameter gear 11 that is fixed to a countershaft 12 of the countershaft unit 4 meshes with the counter gear 8. A gear 14 of the differential unit 5 meshes with the countershaft 12 via a small diameter gear 12a formed on the outer peripheral surface of the countershaft 12. The gear 14 is fixed to a differential gear 13 and is connected to right and left axles 15, 15 via the differential gear 13.

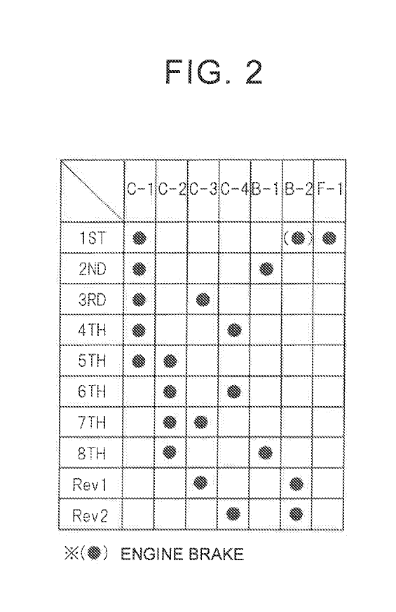

The automatic transmission 1 configured as described above attains first (1st) to eighth (8th) forward speeds and first (Rev1) and second (Rev2) reverse speeds by engagement and disengagement of the first to fourth clutches C-1 to C-4, the first and second brakes B-1, B-2, and the one-way clutch F-1 in the skeleton diagram of FIG. 1 according to the combinations shown in the engagement table of FIG. 2.

As shown in FIG. 2, this automatic transmission 1 attains each of the first to fifth forward speeds by engaging one of the second clutch C-2, the third clutch C-3, the fourth clutch C-4, the first brake B-1, and the second brake B-2 while keeping the first clutch C-1 engaged, and attains each of the sixth to eighth forward speeds by engaging one of the third clutch C-3, the fourth clutch C-4, and the first brake B-1 while keeping the second clutch C-2 engaged. Accordingly, the first clutch C-1 and the second clutch C-2 are main friction engagement elements for each shift speed, and the remaining clutches and brakes, namely the third clutch C-3, the fourth clutch C-4, the first brake B-1, and the second brake B-2, are sub friction engagement elements for each shift speed. In warm-up slip control that will be described in detail later, a friction engagement element that is not relevant to a shift speed is basically caused to slip. If the second clutch C-2 is caused to slip from the first to fourth forward speeds, the second clutch C-2 slips continuously during this period. If the first clutch C-1 is caused to slip from the sixth to eighth forward speeds, the first clutch C-1 slips continuously during this period. This is not preferable in terms of durability because a large amount of heat is generated. In the warm-up slip control, it is therefore preferable to cause the third clutch C-3, the fourth clutch C-4, the first brake B-1, and the second brake B-2 to slip in appropriate order according to the shift speed.

The configuration of a control unit (ECU) 30 for the automatic transmission 1 will be described below with reference to FIG. 3. As shown in FIG. 3, an accelerator operation amount sensor 61 (which may be a throttle opening sensor that detects the throttle opening) that detects the amount by which an accelerator pedal disposed in a driver's seat, not shown, is depressed (accelerator operation amount), a brake sensor 62 that detects the amount by which a brake pedal disposed in the driver's seat, not shown, is depressed, a drive mode switch 63 disposed in the driver's seat, not shown, to select a drive mode of the vehicle (e.g., eco mode, normal mode, sports mode, etc.), a turbine rotational speed sensor 64 that detects the rotational speed of the turbine runner 2c of the torque converter 2 (or the input shaft 7 of the automatic speed change mechanism 3), an output rotational speed sensor (vehicle speed sensor) 65 that detects the vehicle speed by detecting the rotational speed of the counter gear 8 (or the countershaft 12), an oil temperature sensor 66 that detects the temperature of oil (oil temperature) in the automatic transmission 1, etc. are connected to the control unit (ECU) 1. The control unit (ECU) 30 is connected so that it can send command signals to the hydraulic control device 20 that hydraulically controls the automatic speed change mechanism 3.

The control unit (ECU) includes, as means by which a program recorded on a ROM etc. functions, an oil pressure command unit 31, a shift map 33, and a warm-up slip control unit 40. The warm-up slip control unit 40 includes a condition determination unit 41, a slip element decision unit 42, a lubrication pressure increase unit 43, a deceleration operation determination unit 45, an oil temperature determination unit 46, a heat generation calculation unit 47, a vehicle speed determination unit 48, and a deceleration calculation unit 49.

The oil pressure command unit 31 performs electronic control by sending commands to various solenoid valves (not shown) included in the hydraulic control device 20. In the present embodiment, the oil pressure command unit 31 sends command values to linear solenoid valves that control engagement pressures to be supplied to hydraulic servos of the friction engagement elements (the first to fourth clutches C-1 to C-4 and the first and second brakes B-1, B-2). The oil pressure command unit 31 thus performs pressure regulation control to regulate each engagement pressure to control the engagement state (fully engaged state, slip engaged state, and disengaged state) of each friction engagement element as desired. In the present embodiment, the oil pressure command unit 31 also sends a command signal to a solenoid valve that changes the flow rate of a lubrication pressure. The oil pressure command unit 31 thus performs switch control to switch the lubrication pressure to a high or low pressure to change the flow rate of lubricating oil to be supplied into the automatic speed change mechanism 3. Lubricating oil supplied to the automatic speed change mechanism 3 cools, lubricates, etc. the gear mechanisms such as the planetary gear DP and the planetary gear unit PU, friction plates of each friction engagement element, etc. The lubrication pressure may be switched by any method such as by changing the state of pressure regulation by a regulator valve, by switching a lubrication oil passage, etc.

The fully engaged state refers to the state where the friction plates of the fiction engagement element do not slip on each other and transmit 100% of torque. The disengaged state refers to the state where the friction plates of the friction engagement element are separated from each other and do not transmit torque. The slip engaged state refers to an intermediate state between the fully engaged state and the disengaged state, where the friction plates of the fiction engagement element slightly transmit torque.

A speed change decision unit 32 determines a current shift speed, namely makes a speed change decision to change the shift speed, by referring to the shift map 33 based on the accelerator operation amount detected by the accelerator operation amount sensor 61 and the vehicle speed detected by the output rotational speed sensor 65. The oil pressure command unit 31 controls the engagement state of each friction engagement element according to the engagement table of FIG. 2 based on the shift speed determined by the speed change decision unit 32.

If the oil temperature in the automatic transmission 1 is a predetermined temperature or less (e.g., 80° C. or less) and it is determined based on a deceleration operation performed by the driver that the vehicle is in a non-driving state (coast state), the warm-up slip control unit 40 can perform warm-up slip control so that the friction plates of the friction engagement element different from the friction engagement elements being engaged in a non-shifting state, which is the state where a shift speed is maintained after being attained, are caused to slip (hereinafter, the term “friction engagement element” sometimes refer to the friction plates). That is, the condition determination unit 41 basically determines that warm-up slip control should be performed, when the following conditions are satisfied, namely if the oil temperature is the predetermined temperature or less and it is determined that the driver has performed an operation of decelerating the vehicle. In the present embodiment, the condition determination unit 41 allows warm-up slip control to be performed if the following additional conditions are satisfied, namely if the amount of heat that is generated by the friction engagement element to be caused to slip is within an acceptable range, the vehicle speed is a predetermined vehicle speed or less, deceleration of the vehicle is predetermined deceleration or less, the drive mode is the normal mode, the shift speed is the third forward speed or higher (higher than the second forward speed), the vehicle is in a steady traveling state where the shift speed is maintained, the oil temperature is not in a very low temperature state where the oil temperature is lower than the predetermined temperature, etc. In the present embodiment, the term “or less” means “equal to or smaller than a predetermined value, the predetermined value inclusive.” However, the term “or less” may technically mean “smaller than a predetermined value, the predetermined value not inclusive.” That is, the term “or less” may be replaced with the term “less than”.

The non-driving state of the vehicle refers to the state where no driving force is being transmitted from the engine serving as a driving source and a transmission path in the automatic transmission 1 is being rotated by wheels. In other words, the non-driving state of the vehicle refers to the state that is not the driving state where the driving force of the engine is being transmitted to the wheels via the automatic transmission 1. The non-shifting state refers to the state from completion of the previous shifting to the subsequent speed change decision. In other words, the non-shifting sate refers to the state that is not the state during shifting, namely not the state from the start of shifting after a speed change decision to completion of the shifting. Completion of shifting means that a torque phase in which torque sharing is switched when changing the engagement states of the friction engagement elements and an inertia phase in which rotation of the automatic speed change mechanism 3 is changed have been finished.

When the oil temperature enters the very low temperature state where the oil temperature is a predetermined very low temperature (e.g., −20° C.), which is lower than the predetermined temperature, or less, warm-up slip control is stopped. That is, when the oil temperature enters the very low temperature state and lubricating oil has increased viscosity, controllability of the engagement pressures of the friction engagement elements is reduced, which may cause a shock or tie-up. In this case, warm-up slip control is not performed. Namely, an engagement pressure is supplied to the hydraulic servo of the friction engagement elements being engaged to maintain the shift speed, and an oil pressure is not supplied to the friction engagement element different from these friction engagement elements so that this friction engagement element is in a disengaged state. Warm-up slip control is performed when the oil temperature later enters a predetermined temperature range that is higher than the predetermined very low temperature and the predetermined temperature or less. In the present embodiment, warm-up slip control is stopped when the oil temperature enters the very low temperature state. However, in order to quickly increase the oil temperature, warm-up slip control may be performed even in the very low temperature state so that a slight shock or tie-up would be permitted. It may be determined that the oil temperature is in the very low temperature state in the case where the oil temperature is merely the predetermined very low temperature or less. Alternatively, it may be determined that the oil temperature is in the very low temperature state based on, e.g., both the oil temperature and other factor(s), in view of oil viscosity based on the conditions of hydraulic control response etc.

The deceleration operation determination unit 45 determines if the driver has performed an operation of decelerating the vehicle (deceleration operation). Specifically, the deceleration operation determination unit 45 determines that the driver has performed a deceleration operation if it is determined from the accelerator operation amount detected by the accelerator operation amount sensor 61 that the driver has performed an operation of releasing the accelerator pedal (fully closing operation) and it is determined from the amount by which the brake pedal is depressed, which is detected by the brake sensor 62, that the driver has performed an operation of depressing the brake pedal. The deceleration operation determination unit 45 transmits the determination result to the condition determination unit 41. In the present embodiment, the deceleration operation determination unit 45 determines that a deceleration operation has been performed if it is determined that both an operation of releasing the accelerator pedal and an operation of depressing the brake pedal have been performed. However, the deceleration operation determination unit 45 may determine in response to one of the operation of releasing the accelerator pedal and the operation of depressing the brake pedal that a deceleration operation has been performed. Alternatively, the deceleration operation determination unit 45 may determine in response to an operation of any other operation member (e.g., a cruise control switch etc.) that a deceleration operation has been performed.

The oil temperature determination unit 46 determines whether or not the oil temperature detected by the oil temperature sensor 66 is the predetermined oil temperature or less, and transmits the determination result to the condition determination unit 41.

The heat generation calculation unit 47 calculates, by using the gear ratio, the rotational speed difference that is caused in the friction engagement element when the friction engagement element is caused to slip by warm-up slip control, based on the turbine rotational speed detected by the turbine rotational speed sensor 64, the vehicle speed detected by the output rotational speed sensor 65, etc. The heat generation calculation unit 47 calculates the amount of heat that is generated by the friction engagement element, based on the calculated rotational speed difference and the torque share of driving torque that is generated by the deceleration of the vehicle. The heat generation calculation unit 47 determines whether or not the calculated amount of heat is a design amount acceptable for this friction engagement element or less, and transmits the determination result to the condition determination unit 41.

The vehicle speed determination unit 48 determines whether or not the vehicle speed detected by the output rotational speed sensor 65 is the predetermined vehicle speed or less. That is, if warm-up slip control is performed when the vehicle speed is higher than the predetermined vehicle speed, the rotational speed of the friction engagement element that is caused to slip may be high and this friction engagement element may generate an unexpectedly large amount of heat. Accordingly, in order to protect the friction engagement element, the vehicle speed determination unit 48 determines whether or not the vehicle speed is the predetermined vehicle speed or less, and transmits the determination result to the condition determination unit 41.

The deceleration calculation unit 49 differentiates the vehicle speed detected by the output rotational speed sensor to calculate deceleration, and determines whether or not the deceleration is the predetermined deceleration or less. That is, when the deceleration is larger than the predetermined deceleration, the vehicle is being rapidly decelerated, and the vehicle speed decreases rapidly. The speed change decision unit 32 therefore determines frequently in a short period of time that downshifting should be performed, according to the shift map 33. Namely, shifting is performed frequently. When the vehicle is being rapidly decelerated, downshifting one speed by one speed is not sufficient, and downshifting to two or more speeds lower, namely what is called skip shifting, may be performed. If shifting is performed frequently, there may not be enough time for the friction engagement element to cool sufficiently. Moreover, when skip shifting is performed, the friction engagement element slips for a longer period of time due to adjustment of the rotational speed, and therefore may generate a large amount of heat. Accordingly, if the friction engagement element is caused to slip by warm-up slip control, the amount of heat that is generated by the friction engagement element may increase and may become larger than the acceptable amount. The deceleration calculation unit 49 therefore determines whether or not the deceleration is the predetermined deceleration or less, and transmits the determination result to the condition determination unit 41.

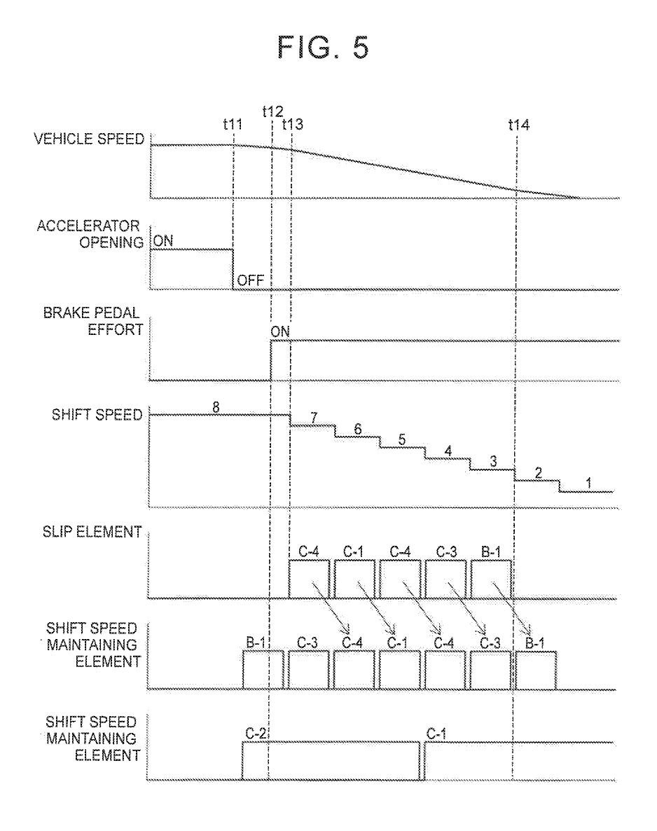

The slip element decision unit 42 decides which of the friction engagement elements should be caused to slip by warm-up slip control. A different friction engagement element is selected for each shift operation so as to prevent the same friction engagement element from being continuously caused to slip and generating the amount of heat larger than the acceptable amount. In the first embodiment, it is assumed that downshifting is performed one speed by one speed according to a decrease in vehicle speed during deceleration of the vehicle. Since the friction engagement element that forms the shift speed after the subsequent downshift can therefore be predicted, the friction engagement element that is supposed to be engaged at the shift speed after the subsequent downshift is selected according to the engagement table of FIG. 2. The slip element decision unit 42 thus selects the friction engagement element to be caused to slip. Selection of the friction engagement element will be specifically described later with reference to the timing chart of FIG. 5.

When performing warm-up slip control, the lubrication pressure increase unit 43 sends a command to the hydraulic control device 20 by sending a command to the oil pressure command unit 31, thereby increasing the lubrication pressure to a value higher than a normal oil pressure. When the lubrication pressure is increased, the flow rate of lubricating oil that is supplied into automatic speed change mechanism 3 increases accordingly. As a result, a larger amount of lubricating oil is supplied to the friction engagement element in a slipping state. The larger amount of lubricating oil absorbs a larger amount of heat, whereby the friction engagement element is cooled. Moreover, the increased flow rate of the lubricating oil prevents seizure etc. Since warm-up slip control is intended to increase the oil temperature, circulating a large amount of lubricating oil in the friction engagement element that serves as a heat source in the automatic speed change mechanism 3 is expected to facilitate an increase in oil temperature by heat convection.

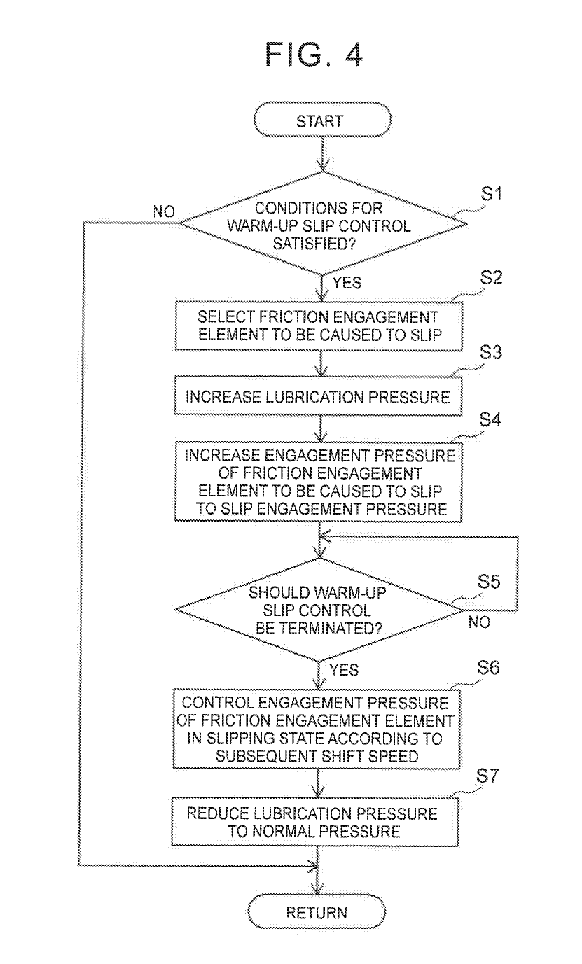

Warm-up slip control that is performed by the control unit 30 will be described with reference to FIG. 4. As shown in FIG. 4, for example, when a start switch of the vehicle is turned on, the warm-up slip control is started. The condition determination unit 41 first determines if conditions for performing warm-up slip control are satisfied (S1). For example, when the vehicle is being accelerated with the accelerator pedal being depressed, the conditions are not satisfied (S1, No) even if the oil temperature is the predetermined oil temperature or less, because it is determined by the deceleration operation determination unit 45 that a deceleration operation has not been performed. The routine therefore returns to a standby state.

Thereafter, for example, if the oil temperature is still the predetermined oil temperature or less, an operation of releasing the accelerator pedal and an operation of depressing the brake pedal are detected, it is determined by the deceleration operation determination unit 45 that a deceleration operation has been performed, and it is determined that all of the conditions described above (the amount of heat that is generated is the acceptable amount or less, the vehicle speed is the predetermined vehicle speed or less, deceleration is the predetermined deceleration or less, the drive mode is the normal mode, the shift speed is the third forward speed or higher, the vehicle is in the steady state where the shift speed is maintained, the oil temperature is not in the very low temperature state, etc.) are satisfied, (S1, Yes), the slip element decision unit 42 first selects the friction engagement element to be caused to slip (S2). In the first embodiment, the slip element decision unit 42 selects the friction engagement element to be engaged by the subsequent downshift.

Subsequently, the lubrication pressure increase unit 43 sends a command to the hydraulic control device 20 to increase the lubrication pressure (S3), and the oil pressure command unit 31 sends a command to the hydraulic control device 20 to increase the engagement pressure to be supplied to the hydraulic servo of the friction engagement element selected by the slip element decision unit 42 to a slip engagement pressure that causes the friction engagement element to slip (S4). As a result, the friction engagement element different from the friction engagement elements being engaged while the shift speed is maintained is caused to slip, whereby the warm-up slip control is substantially started. The present embodiment is described with respect to the case where the lubrication pressure is increased. However, control to increase the lubrication pressure need not necessarily be performed.

Thereafter, step S5 is repeated until it is determined by the condition determination unit 41 that the conditions are no longer satisfied and that the warm-up slip control should be terminated (S5, No). For example, if the speed change decision unit 32 makes a speed change decision during the warm-up slip control, the vehicle is no longer in the steady state where the shift speed is maintained, and it is determined that the warm-up slip control should be terminated (S5, Yes). Accordingly, a command is sent to the hydraulic control device 20 to control the engagement pressure of the friction engagement element in a slipping state according to the subsequent shift speed based on the speed change decision (S6). Namely, in the first embodiment, a command is sent to the hydraulic control device 20 to increase the engagement pressure to engage the friction engagement element that is in a slipping state. A command is also sent to the hydraulic control device 20 to reduce the lubrication pressure to a normal pressure (S7). The warm-up slip control is thus terminated, and the routine waits until the conditions for warm-up slip control are satisfied again.

Subsequently, if shifting is performed based on the speed change decision and the condition determination unit 41 determines after the shifting is completed that the conditions for warm-up slip control are satisfied (S1, Yes), the slip element determination unit 42 again selects the friction engagement element to be caused to slip. Commands are sent to the hydraulic control device 20 to increase the lubrication pressure (S3) and to increase the engagement pressure to be supplied to the hydraulic servo of the friction engagement element selected by the slip element decision unit 42 to a slip engagement pressure that causes the friction engagement element to slip (S4). Step S5 is repeated until it is determined by the condition determination unit 41 that the conditions are no longer satisfied and that the warm-up slip control should be terminated (S5, No). For example, if the speed change decision unit 32 makes a speed change decision, it is determined that the warm-up slip control should be terminated (S5, Yes). Accordingly, a command is sent to the hydraulic control device 20 to increase the engagement pressure to engage the friction engagement element that is in a slipping state (S6). A command is also sent to the hydraulic control device 20 to reduce the lubrication pressure to the normal pressure (S7). The routine waits until the conditions for warm-up slip control are satisfied again.

Subsequently, steps S2 to S7 are repeatedly performed every time the conditions for warm-up slip control are satisfied. If the conditions for warm-up slip control continue to be unsatisfied such as, e.g., when the shift speed is the second forward speed or when warm-up is completed as the oil temperature becomes higher than the predetermined oil temperature (S1, Yes), the routine returns to the standby state. Namely, the routine waits until the conditions for warm-up slip control are satisfied again.

In the present embodiment, warm-up slip control is performed under the condition that it is determined by the condition determination unit 41 that the vehicle is in the steady traveling state where the shift speed is maintained. However, the condition determination unit 41 need not necessarily determine if the vehicle is in the steady traveling state where the shift speed is maintained, and warm-up slip control may be temporarily stopped until shifting is completed after a speed change decision is made. That is, in the present embodiment, warm-up slip control is stopped every time shifting is performed, and warm-up slip control is started when the vehicle is in the steady traveling state where the shift speed is maintained. However, there is technically no problem even if the program is created so that warm-up slip control is not started and stopped based on shifting.

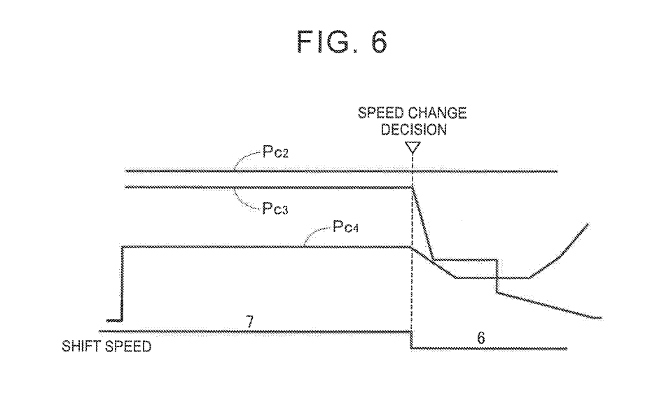

An example in which the vehicle travels according to the warm-up slip control of the first embodiment will be described with reference to FIGS. 5 and 6. For example, it is assumed that the vehicle has been stopped for a long period of time and the oil temperature of the automatic transmission 1 is the predetermined oil temperature or less, and in this state, the drive mode is switched to the normal mode and the vehicle is started. Thereafter, as shown in FIG. 5, the conditions for warm-up slip control are satisfied if the driver performs an operation of releasing the accelerator pedal at time t11 and performs an operation of depressing the brake pedal at time t12 when the vehicle is traveling at the predetermined vehicle speed or higher and at the eighth forward speed. Since the vehicle speed is reduced by deceleration due to braking, shifting to the seventh forward speed is performed at time t13.

At the seventh forward speed, the second clutch C-2 and the third clutch C-3, which are the friction engagement elements maintaining the shift speed (shift speed maintaining elements), are in an engaged state. When the subsequent downshifting to one speed lower is performed according to a decrease in vehicle speed, the sixth forward speed is supposed to be formed at which the second clutch C-2 and the fourth clutch C-4 serving as the shift speed maintaining elements are engaged. The slip element decision unit 42 therefore selects the fourth clutch C-4 as the friction engagement element to be caused to slip, and performs warm-up slip control to cause the fourth clutch C-4 to slip.

Command control of the engagement pressure which is performed when the vehicle speed actually decreases and downshifting to one speed lower, namely downshifting from the seventh forward speed to the sixth forward speed, is performed will be described with reference to FIG. 6. As shown in FIG. 6, at the seventh forward speed, in order to engage the second clutch C-2 and the third clutch C-3, a command is sent so that an engagement pressure P_{C2} to be supplied to the hydraulic servo of the second clutch C-2 and an engagement pressure P_{C3} to be supplied to the hydraulic servo of the third clutch C-3 have such high values that line pressures are supplied thereto as they are. In order to cause the fourth clutch C-4 to slip in this state, an engagement pressure P_{C4} to be supplied to the hydraulic servo of the fourth clutch C-4 is increased to such a slip engagement pressure that causes the fourth clutch C-4 to slip.

The magnitude of the slip engagement pressure is such a magnitude that the friction engagement element that is caused to slip slightly transmits torque. For example, if the magnitude of the engagement pressure according to a command is too large, the friction engagement element different from the friction engagement elements maintaining the shift speed may also be engaged without being caused to slip, in addition to the friction engagement elements maintaining the shift speed, and rotation of the automatic speed change mechanism 3 may be stopped. Accordingly, the magnitude of the engagement pressure needs to be maintained so that the friction engagement element caused to slip keeps slipping at least by the inertial force of the vehicle.

As shown in FIG. 6, when a speed change decision is made to perform shifting to the sixth forward speed, the engagement pressure P₃ is reduced to disengage the third clutch C-3. At this time, if the fourth clutch C-4 in a slipping state continues to slip, a shift control method for the shifting that is performed by changing the engagement states of the friction engagement elements needs to be changed from a normal shift control method. Accordingly, the engagement pressure P_{C4} of the fourth clutch C-4 in a slipping state is reduced to attain the state where fast filling of the hydraulic servo of the fourth clutch C-4 has been finished and engagement of the fourth clutch C-4 has not been started (the fourth clutch C-4 is not in a slipping state) as in the case of the normal shifting that is performed by changing the engagement states of the friction engagement elements. Subsequently, as in the normal shifting that is performed by changing the engagement states of the friction engagement elements, the engagement pressure P_{C3} of the third clutch C-3 is reduced to disengage the third clutch C-3, and the engagement pressure P_{C4} of the fourth clutch C-4 is increased to engage the fourth clutch C-4. Shifting to the sixth forward speed is thus completed.

Subsequently, as shown in FIG. 5, at the sixth forward speed, the second clutch C-2 and the fourth clutch C-4, which are the friction engagement elements maintaining the shift speed (shift speed maintaining elements), are in an engaged state. When the subsequent downshifting is performed according to a decrease in vehicle speed, the fifth forward speed is supposed to be formed at which the second clutch C-2 and the first clutch C-1 serving as the shift speed maintaining elements are engaged. The slip element decision unit 42 therefore selects the first clutch C-1 as the friction engagement element to be caused to slip, and performs warm-up slip control to cause the fourth clutch C-4 to slip.

Thereafter, downshifting to the fifth forward speed is actually performed. At the fifth forward speed, the second clutch C-2 and the first clutch C-1, which are the friction engagement elements maintaining the shift speed (shift speed maintaining elements), are in an engaged state. When the subsequent downshifting is performed according to a decrease in vehicle speed, the fourth forward speed is supposed to be formed at which the first clutch C-1 and the fourth clutch C-4 serving as the shift speed maintaining elements are engaged. The slip element decision unit 42 therefore selects the fourth clutch C-4 as the friction engagement element to be caused to slip, and performs warm-up slip control to cause the fourth clutch C-4 to slip.

Thereafter, downshifting to the fourth forward speed is actually performed. At the fourth forward speed, the first clutch C-1 and the fourth clutch C-4, which are the friction engagement elements maintaining the shift speed (shift speed maintaining elements), are in an engaged state. When the subsequent downshifting is performed according to a decrease in vehicle speed, the third forward speed is supposed to be formed at which the first clutch C-1 and the third clutch C-3 serving as the shift speed maintaining elements are engaged. The slip element decision unit 42 therefore selects the third clutch C-3 as the friction engagement element to be caused to slip, and performs warm-up slip control to cause the third clutch C-3 to slip.

Thereafter, downshifting to the third forward speed is actually performed. At the third forward speed, the first clutch C-1 and the third clutch C-3, which are the friction engagement elements maintaining the shift speed (shift speed maintaining elements), are in an engaged state. When the subsequent downshifting is performed according to a decrease in vehicle speed, the second forward speed is supposed to be formed at which the first clutch C-1 and the first brake B-1 serving as the shift speed maintaining elements are engaged. The slip element decision unit 42 therefore selects the first brake B-1 as the friction engagement element to be caused to slip, and performs warm-up slip control to cause the first clutch B-1 to slip.

Thereafter, downshifting to the second forward speed is actually performed. At the second forward speed, the first clutch C-1 and the first brake B-1, which are the friction engagement elements maintaining the shift speed (shift speed maintaining elements), are in an engaged state. Since warm-up slip control is performed under the condition that the shift speed is the third forward speed or higher, warm-up slip control is terminated at the second forward speed. That is, when it is determined that the shift speed should be changed to the second forward speed or the first forward speed, the vehicle is about to come to a stop, and the inertial force of the vehicle is small. Accordingly, if warm-up slip control is performed in this state, deceleration of the automatic transmission 1 is increased by drag torque of the friction engagement element caused to slip, which may give an unintended feeling of deceleration. Warm-up slip control is therefore not performed.

Subsequently, shifting to the first forward speed is performed, and the vehicle speed of the vehicle becomes equal to 0, namely the vehicle comes to a stop. This example in which the vehicle travels according to the warm-up slip control is thus terminated. Since the first forward speed of the automatic transmission 1 can be attained by the one-way clutch F-1, shifting to the first forward speed is performed by engaging only the first clutch C-1 without particularly engaging the second brake B-2.

In the automatic transmission 1 according to the first embodiment described above, the friction engagement element that is different from the friction engagement elements being engaged while the shift speed is maintained during deceleration of the vehicle is caused to slip. Accordingly, the friction engagement element can be in a slipping state for a long time as long as the vehicle is being decelerated. Warm-up can therefore be completed quickly. The friction engagement element is not caused to slip by the driving force of the engine, but is caused to slip by the inertial force of the vehicle. Accordingly, fuel of the engine need not be consumed for slipping, whereby fuel economy of the vehicle can also be improved. When the friction engagement element different from the friction engagement elements being in the engaged state is caused to slip while the shift speed is maintained, a force to decelerate the vehicle is generated. However, performing warm-up slip control in response to an operation of decelerating the vehicle prevents the driver with an intention to decelerate the vehicle from feeling discomfort.

The friction engagement element to be caused to slip is changed for each shift operation. This can prevent only one friction engagement element from continuously generating heat, and can thus prevent influence on durability of the friction engagement elements and can prevent reduction in durability of the automatic transmission 1. In particular, since the friction engagement element that is supposed to be engaged in the subsequent downshifting is caused to slip, shifting to the subsequent shift speed can be performed quickly, and responsive shifting can thus be achieved.

When deceleration of the vehicle is larger than the predetermined deceleration, namely when the vehicle is being rapidly decelerated, frequent shifting or skip shifting, namely shifting to two or more speeds lower, tends to occur due to a rapid decrease in vehicle speed, and each friction engagement element may generate a large amount of heat. However, since warm-up slip control is not permitted unless the deceleration is the predetermined deceleration or less, the friction engagement element can be prevented from being engaged immediately after being caused to slip and thus can be prevented from generating an excessively large amount of heat. This can prevent influence on durability of the friction engagement elements.

The amount of heat that is generated by the friction engagement element to be caused to slip is calculated and warm-up slip control is performed when the calculated amount of heat is the acceptable amount or less. This can prevent the amount of heat that is generated by slipping from becoming larger than the acceptable amount for the friction engagement element, and can prevent influence on durability of the friction engagement elements.

Since the lubrication pressure is increased during warm-up slip control, the friction engagement element that is caused to slip by the warm-up slip control can be cooled with a larger amount of lubricating oil. This can prevent influence on durability of the friction engagement elements.

### Second Embodiment

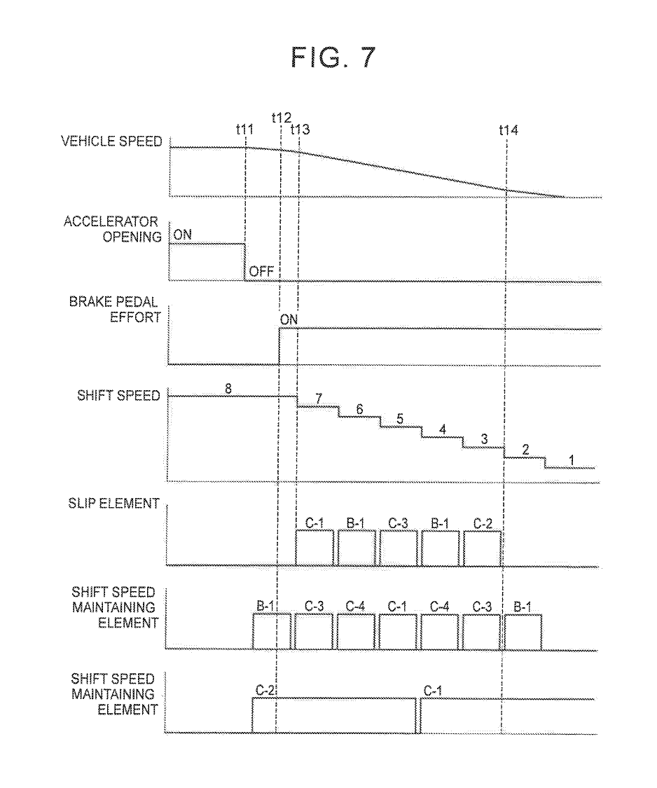

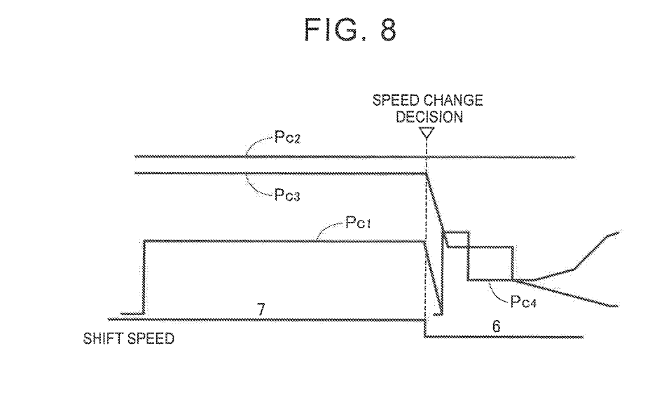

A second embodiment, which is a partial modification of the first embodiment, will be described with reference to FIGS. 7 and 8. In the second embodiment, when deciding which of the friction engagement elements is to be caused to slip in warm-up slip control, the slip element decision unit 42 selects the friction engagement element other than the friction engagement elements that are to be engaged at the shift speed to be attained by upshifting to one speed higher or downshifting to one speed lower. In other words, in the case where downshifting is sequentially performed one speed by one speed according to a decrease in vehicle speed, the friction engagement element that had been engaged at one speed higher than the current shift speed but has just been disengaged and the friction engagement elements that are supposed to be engaged at the shift speed to be attained by the subsequent downshifting are not used, and the friction engagement element to be engaged at two or more speeds lower or higher than the current shift speed is used in order to prevent the friction engagement element from being continuously caused to slip and thus prevent accumulation of heat generated by the friction engagement element.

Specifically, as shown in FIG. 7, the conditions for warm-up slip control are satisfied if the driver performs an operation of releasing the accelerator pedal at time t11 and performs an operation of depressing the brake pedal at time t12 when the vehicle is traveling at the predetermined vehicle speed or higher and at the eighth forward speed. Since the vehicle speed is reduced by deceleration due to braking, shifting to the seventh forward speed is performed at time t13.

At the seventh forward speed, the second clutch C-2 and the third clutch C-3, which are the shift speed maintaining elements, are in an engaged state. When the subsequent downshifting to one speed lower is performed according to a decrease in vehicle speed, the sixth forward speed is supposed to be formed at which the second clutch C-2 and the fourth clutch C-4 serving as the shift speed maintaining elements are engaged. The slip element decision unit 42 therefore selects, as the friction engagement element to be caused to slip, the first clutch C-1 that is not engaged at the eighth forward speed and the sixth forward speed (that is engaged at the first to fifth forward speeds), and performs warm-up slip control to cause the first clutch C-1 to slip.

Command control of the engagement pressure which is performed when the vehicle speed actually decreases and downshifting to one speed lower, namely downshifting from the seventh forward speed to the sixth forward speed, is performed will be described with reference to FIG. 8. As shown in FIG. 8, at the seventh forward speed, in order to engage the second clutch C-2 and the third clutch C-3, a command is sent so that the engagement pressure P_{C2} to be supplied to the hydraulic servo of the second clutch C-2 and the engagement pressure P_{C3} to be supplied to the hydraulic servo of the third clutch C-3 have such high values that line pressures are supplied thereto as they are. In order to cause the first clutch C-1 to slip in this state, an engagement pressure P_{C1} to be supplied to the hydraulic servo of the first clutch C-1 is increased to such a slip engagement pressure that causes the first clutch C-1 to slip.

When a speed change decision is made to perform shifting to the sixth forward speed, the engagement pressure P_{C3} is reduced to disengage the third clutch C-3. At this time, the engagement pressure P_{C1} of the first clutch C-1 in a slipping state is reduced so that there is no friction engagement element in a slipping state during shifting. As in the normal shifting that is performed by changing the engagement states of the friction engagement elements, fast filling of the hydraulic servo of the fourth clutch C-4 is performed, and then the engagement pressure P_{C3} of the third clutch C-3 is reduced to disengage the third clutch C-3 and the engagement pressure P_{C4} of the fourth clutch C-4 is increased to engage the fourth clutch C-4. Shifting to the sixth forward speed is thus completed.

Subsequently, as shown in FIG. 7, at the sixth forward speed, the second clutch C-2 and the fourth clutch C-4, which are the friction engagement elements maintaining the shift speed (shift speed maintaining elements), are in an engaged state. The slip element decision unit 42 selects, as the friction engagement element to be caused to slip, the first brake B-1 that are not engaged at the seventh forward speed and the fifth forward speed (that are engaged at the second forward speed and the eighth forward speed), and performs warm-up slip control to cause the first brake B-1 to slip.

Thereafter, downshifting to the fifth forward speed is actually performed. At the fifth forward speed, the second clutch C-2 and the first clutch C-1, which are the friction engagement elements maintaining the shift speed (shift speed maintaining elements), are in an engaged state. The slip element decision unit 42 selects, as the friction engagement element to be caused to slip, the third clutch C-3 that are not engaged at the sixth forward speed and the fourth forward speed (that are engaged at the third forward speed and the seventh forward speed), and performs warm-up slip control to cause the third clutch C-3 to slip.

Thereafter, downshifting to the fourth forward speed is actually performed. At the fourth forward speed, the first clutch C-1 and the fourth clutch C-4, which are the friction engagement elements maintaining the shift speed (shift speed maintaining elements), are in an engaged state. The slip element decision unit 42 selects, as the friction engagement element to be caused to slip, the first brake B-1 that are not engaged at the fifth forward speed and the third forward speed (that are engaged at the second forward speed and the eighth forward speed), and performs warm-up slip control to cause the first brake B-1 to slip.

Thereafter, downshifting to the third forward speed is actually performed. At the third forward speed, the first clutch C-1 and the third clutch C-3, which are the friction engagement elements maintaining the shift speed (shift speed maintaining elements), are in an engaged state. The slip element decision unit 42 selects, as the friction engagement element to be caused to slip, the second clutch C-2 that are not engaged at the fourth forward speed and the second forward speed (that are engaged at the fifth to eighth forward speeds), and performs warm-up slip control to cause the second clutch C-2 to slip.

Thereafter, downshifting to the second forward speed is actually performed. At the second forward speed, the first clutch C-1 and the first brake B-1, which are the friction engagement elements maintaining the shift speed (shift speed maintaining elements), are in an engaged state. Since warm-up slip control is performed under the condition that the shift speed is the third forward speed or higher, warm-up slip control is terminated at the second forward speed.

Subsequently, shifting to the first forward speed is performed, and the vehicle speed of the vehicle becomes equal to 0, namely the vehicle comes to a stop. This example in which the vehicle travels according to the warm-up slip control is thus terminated. Since the first forward speed of the automatic transmission 1 can be attained by the one-way clutch F-1, shifting to the first forward speed is performed by engaging only the first clutch C-1 without particularly engaging the second brake B-2.

In the automatic transmission 1 according to the second embodiment described above, the friction engagement element to be caused to slip is changed for each shift operation. This can prevent only one friction engagement element from continuously generating heat. The friction engagement element in a slipping state is not continuously engaged as long as shifting is performed one speed by one speed. Accordingly, heat generation is not continuously accumulated in this friction engagement element, which can prevent influence on durability of the friction engagement elements.

Since other configurations, functions, and effects are similar to those of the first embodiment described above, description thereof will be omitted.

### Third Embodiment

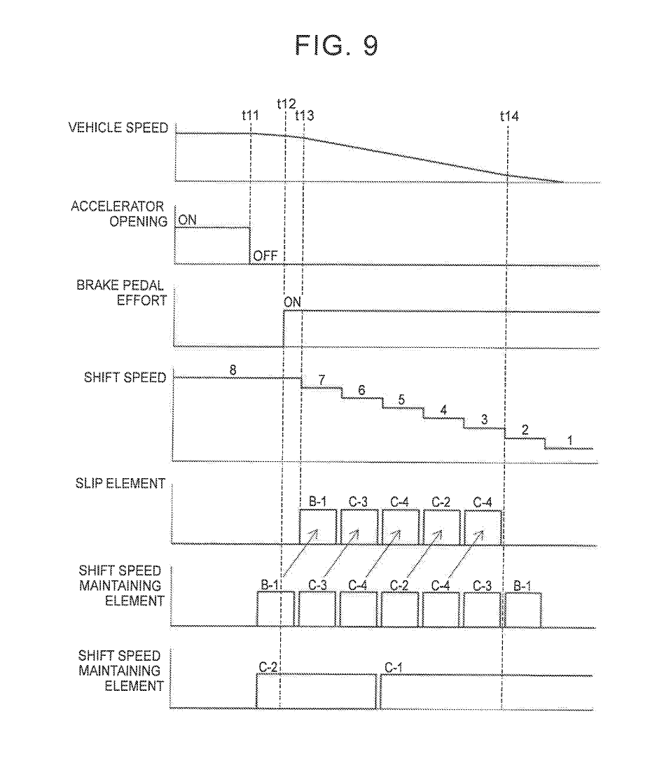

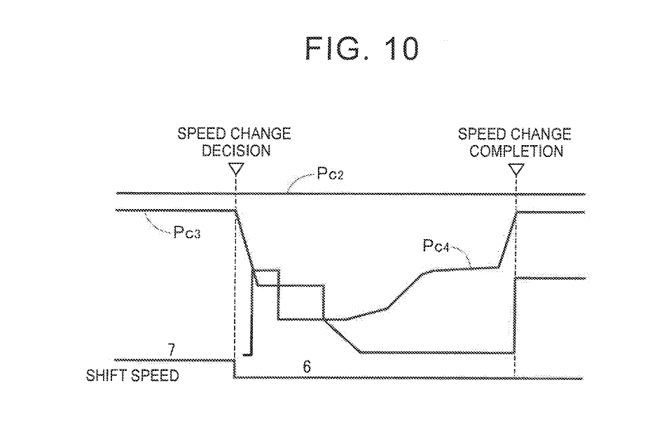

A third embodiment, which is a partial modification of the first and second embodiments, will be described with reference to FIGS. 9 and 10. In the third embodiment, when deciding which of the friction engagement elements is to be caused to slip in warm-up slip control, the slip element determination unit 42 selects the friction engagement element that was in an engaged state before shifting.

Specifically, as shown in FIG. 9, the conditions for warm-up slip control are satisfied if the driver performs an operation of releasing the accelerator pedal at time t11 and performs an operation of depressing the brake pedal at time t12 when the vehicle is traveling at the predetermined vehicle speed or higher and at the eighth forward speed. Since the vehicle speed is reduced by deceleration due to braking, shifting to the seventh forward speed is performed at time t13.

At the seventh forward speed, the second clutch C-2 and the third clutch C-3, which are the shift speed maintaining elements, are in an engaged state. The slip element decision unit 42 selects, as the friction engagement element to be caused to slip, the first brake B-1 that was in an engaged state at the eighth forward speed, and performs warm-up slip control to cause the first brake B-1 to slip.

Command control of the engagement pressure which is performed when the vehicle speed actually decreases and downshifting to one speed lower, namely downshifting from the seventh forward speed to the sixth forward speed, is performed will be described with reference to FIG. 10. As shown in FIG. 10, at the seventh forward speed, in order to engage the second clutch C-2 and the third clutch C-3, a command is sent so that the engagement pressure P_{C2} to be supplied to the hydraulic servo of the second clutch C-2 and the engagement pressure P_{C3} to be supplied to the hydraulic servo of the third clutch C-3 have such high values that line pressures are supplied thereto as they are.

When a speed change decision is made to perform shifting to the sixth forward speed, the engagement pressure P_{C3} is reduced to disengage the third clutch C-3. At this time, although not shown in the figure, an engagement pressure P_{B1} of the first brake B-1 that is in a slipping state at the seventh forward speed is reduced so that there is no friction engagement element in a slipping state during shifting. As in the normal shifting that is performed by changing the engagement states of the friction engagement elements, fast filling of the hydraulic servo of the fourth clutch C-4 is performed, and then the engagement pressure P_{C3} of the third clutch C-3 is reduced to disengage the third clutch C-3 and the engagement pressure P_{C4} of the fourth clutch C-4 is increased to engage the fourth clutch C-4. Shifting to the sixth forward speed is thus completed. When shifting to the sixth forward speed is completed, the engagement pressure P_{C3} reduced to disengage the third clutch C-3 is increased again to a slip engagement pressure to cause the third clutch C-3 to slip.

Subsequently, as shown in FIG. 9, at the sixth forward speed, the second clutch C-2 and the fourth clutch C-4, which are the friction engagement elements maintaining the shift speed (shift speed maintaining elements), are in an engaged state. The slip element decision unit 42 selects, as the friction engagement element to be caused to slip, the third clutch C-3 that was in an engaged state at the seventh forward speed, and performs warm-up slip control to cause the third clutch C-3 to slip.

Thereafter, downshifting to the fifth forward speed is actually performed. At the fifth forward speed, the second clutch C-2 and the first clutch C-1, which are the friction engagement elements maintaining the shift speed (shift speed maintaining elements), are in an engaged state. The slip element decision unit 42 selects, as the friction engagement element to be caused to slip, the fourth clutch C-4 that was in an engaged state at the sixth forward speed, and performs warm-up slip control to cause the fourth clutch C-4 to slip.

Thereafter, downshifting to the fourth forward speed is actually performed. At the fourth forward speed, the first clutch C-1 and the fourth clutch C-4, which are the friction engagement elements maintaining the shift speed (shift speed maintaining elements), are in an engaged state. The slip element decision unit 42 selects, as the friction engagement element to be caused to slip, the first clutch C-1 that was in an engaged state at the fifth forward speed, and performs warm-up slip control to cause the first clutch C-1 to slip.

Thereafter, downshifting to the third forward speed is actually performed. At the third forward speed, the first clutch C-1 and the third clutch C-3, which are the friction engagement elements maintaining the shift speed (shift speed maintaining elements), are in an engaged state. The slip element decision unit 42 selects, as the friction engagement element to be caused to slip, the fourth clutch C-4 that was in an engaged state at the fourth forward speed, and performs warm-up slip control to cause the fourth clutch C-4 to slip.

Thereafter, downshifting to the second forward speed is actually performed. At the second forward speed, the first clutch C-1 and the first brake B-1, which are the friction engagement elements maintaining the shift speed (shift speed maintaining elements), are in an engaged state. Since warm-up slip control is performed under the condition that the shift speed is the third forward speed or higher, warm-up slip control is terminated at the second forward speed.

Subsequently, shifting to the first forward speed is performed, and the vehicle speed of the vehicle becomes equal to 0, namely the vehicle comes to a stop. This example in which the vehicle travels according to the warm-up slip control is thus terminated. Since the first forward speed of the automatic transmission 1 can be attained by the one-way clutch F-1, shifting to the first forward speed is performed by engaging only the first clutch C-1 without particularly engaging the second brake B-2.

In the automatic transmission 1 according to the third embodiment described above, the friction engagement element to be caused to slip is changed for each shift operation. This can prevent only one friction engagement element from continuously generating heat. Since the friction engagement element that was in an engaged state at the shift speed before shifting is caused to slip, the friction engagement element to be caused to slip by warm-up slip control can be highly responsively caused to slip.

Since other configurations, functions, and effects are similar to those of the first embodiment described above, description thereof will be omitted.

<Summary of First to Third Embodiments>

The automatic transmission (1) includes: a speed change mechanism (3) including a gear mechanism (DP, PU) that can attain a plurality of shift speeds, and a plurality of friction engagement elements (C-1 to C-4, B-1, B-2) that are selectively engaged to attain each shift speed in the gear mechanism (DP, PU); a hydraulic control device (20) that can regulate engagement pressures to be supplied to hydraulic servos of the plurality of friction engagement elements (C-1 to C-4, B-1, B-2) and that can supply lubricating oil that lubricates the speed change mechanism (3); and a control unit (30) that sends a command about the engagement pressures to the hydraulic control device (20) to control engagement states of the plurality of friction engagement elements (C-1 to C-4, B-1, B-2). When a vehicle is in a non-driving state and a non-shifting state where the shift speed is maintained and an oil temperature is higher than a predetermined temperature, the control unit (30) supplies an engagement pressure to a hydraulic servo of a friction engagement element being in an engaged state and maintaining the shift speed, and does not supply an oil pressure so as to disengage a different friction engagement element of the friction engagement elements, the different friction engagement element being different from the friction engagement element being in the engaged state. When the vehicle is in the non-driving state and the non-shifting state where the shift speed is maintained and the oil temperature is the predetermined temperature or less, the control unit supplies the engagement pressure to the hydraulic servo of the friction engagement element being in the engaged state and maintaining the shift speed, and supplies an oil pressure so that the different friction engagement element different from the friction engagement element being in the engaged state is in a slipping state.

When the vehicle is in the non-driving state and the non-shifting state where the shift speed is maintained, the different friction engagement element that is different from the friction engagement element being engaged is caused to slip. Accordingly, the friction engagement element can be in the slipping state for a long time as long as the vehicle is being decelerated. Warm-up can therefore be completed quickly. The friction engagement element is not caused to slip by the driving force of a driving source, but is caused to slip by the inertial force of the vehicle. Accordingly, fuel of the driving source need not be consumed for slipping, whereby fuel economy of the vehicle can also be improved. When the different friction engagement element different from the friction engagement element being in the engaged state is caused to slip while the shift speed is maintained, a force to decelerate the vehicle is generated. However, performing warm-up slip control in response to an operation of decelerating the vehicle prevents the driver with an intention to decelerate the vehicle from feeling discomfort.

In the automatic transmission (1), the control unit (30) determines in response to an operation of releasing an accelerator pedal that a deceleration operation for the vehicle is performed.

Since the driver's intention to decelerate the vehicle is reflected, the driver can be prevented from feeling discomfort.

In the automatic transmission (1), the control unit (30) determines in response to an operation of depressing a brake pedal that a deceleration operation for the vehicle is performed.

Since the driver's intention to decelerate the vehicle is reflected, the driver can be prevented from feeling discomfort.

In the automatic transmission (1), the slipping state is a state where the fiction engagement element slightly transmits torque.

In the automatic transmission (1), the non-shifting state is a state from completion of previous shifting to a subsequent speed change decision.

In the automatic transmission (1), the control unit (30) changes, for each shift operation, the friction engagement element to be caused to slip.

Since the friction engagement element to be caused to slip is changed for each shift operation, this can prevent only one friction engagement element from continuously generating heat, and can thus prevent influence on durability of the friction engagement elements and can prevent reduction in durability of the automatic transmission.

Specifically, in the automatic transmission (1), when causing the different friction engagement element to slip, the control unit (30) causes the friction engagement element, which is expected to be engaged by subsequent downshifting according to a decrease in vehicle speed, to slip.

Since the friction engagement element to be caused to slip is changed for each shift operation, this can prevent only one friction engagement element from continuously generating heat. Since the friction engagement element that is supposed to be engaged by the subsequent downshifting is caused to slip, shifting to the subsequent shift speed can be performed quickly, and responsive shifting can thus be achieved.

Specifically, in the automatic transmission (1), when causing the different friction engagement element to slip, the control unit (30) causes the friction engagement element other than the friction engagement element that is to be engaged at the shift speed to be attained by upshifting to one speed higher or downshifting to one speed lower to slip out of the plurality of friction engagement elements.

Since the friction engagement element to be caused to slip is changed for each shift operation, this can prevent only one friction engagement element from continuously generating heat. The friction engagement element in a slipping state is not continuously engaged as long as shifting is performed one speed by one speed. Accordingly, heat generation is not continuously accumulated in this friction engagement element, which can prevent influence on durability of the friction engagement elements.

Specifically, in the automatic transmission (1), when causing the different friction engagement element to slip, the control unit (30) causes the friction engagement element engaged at the shift speed before shifting to slip.

Since the friction engagement element to be caused to slip is changed for each shift operation, this can prevent only one friction engagement element from continuously generating heat. Since the friction engagement element engaged at the shift speed before shifting is caused to slip, the friction engagement element that is to be caused to slip can be highly responsively caused to slip.

In the automatic transmission (1), the control unit (30) allows the different friction engagement element to slip when deceleration of the vehicle is predetermined deceleration or less.

When the deceleration of the vehicle is larger than the predetermined deceleration, namely when the vehicle is being rapidly decelerated, frequent shifting or skip shifting, namely shifting to two or more speeds lower, tends to occur due to a rapid decrease in vehicle speed, and each friction engagement element may generate a large amount of heat. In this case, however, the different friction engagement element is not allowed to slip. The friction engagement element can therefore be prevented from being engaged immediately after being caused to slip and thus can be prevented from generating an excessively large amount of heat. This can prevent influence on durability of the friction engagement elements.

In the automatic transmission (1), the control unit (30) calculates an amount of heat that is generated by the friction engagement element to be caused to slip, and allows the different friction engagement element to slip when the calculated amount of heat is an acceptable amount or less.

This can prevent the amount of heat that is generated by slipping from becoming larger than the acceptable amount for the friction engagement element, and can prevent influence on durability of the friction engagement elements.

In the automatic transmission (1), the hydraulic control device (20) can change an oil pressure of the lubricating oil that lubricates the speed change mechanism (3), and when causing the different friction engagement element to slip, the control unit (30) increases the oil pressure of the lubricating oil to a value higher than that before the friction engagement element is caused to slip.

Accordingly, causing the different friction engagement element to slip allows cooling the friction engagement element caused to slip with a larger amount of lubricating oil. This can prevent influence on durability of the friction engagement elements.

In the automatic transmission (1), when the vehicle is in the non-driving state and the non-shifting state where the shift speed is maintained and the oil temperature is in a very low temperature state, the control unit (30) supplies the engagement pressure to the hydraulic servo of the friction engagement element being in the engaged state and maintaining the shift speed, and does not supply an oil pressure so as to disengage the friction engagement element different from the friction engagement element being in the engaged state.

This can prevent the different friction engagement element from being caused to slip in the very low temperature state and can thus prevent a shock or tie-up from being caused.

### Other Possible Embodiments

In the first to third embodiments, warm-up slip control is performed under the conditions that the drive mode of the vehicle is the normal mode, the vehicle speed is a predetermined vehicle speed or less, deceleration of the vehicle is predetermined deceleration or less, the amount of heat that is generated by the friction engagement element to be caused to slip is an acceptable amount or less, and the shift speed is the third forward speed or higher. However, not all of these conditions need to be satisfied, and the conditions may be changed as appropriate. For example, there may be no such conditions, or any desired combination of the conditions may be used. For example, warm-up slip control may be performed even when the drive mode of the vehicle is the eco mode or the sports mode. For example, warm-up slip control may be performed under the condition that the shift speed is the second forward speed or higher, or under the condition that the shift speed is the fourth forward speed or higher. The shift speed range in which warm-up slip control is performed may be set to any range. There may be no condition of the shift speeds.

The first to third embodiments are described with respect to the case where the automatic transmission 1 attains eight forward speeds and two reverse speeds. However, the automatic transmission 1 may be an automatic transmission that attains any number of shift speeds, such as an automatic transmission that attains six forward speeds and one reverse speed or an automatic transmission that attains ten forward speeds and one reverse speed.

In the first to third embodiments, the three patterns are described in which the slip element decision unit 42 selects the friction engagement element to be caused to slip. However, the present disclosure is not limited to this, and the friction engagement element to be caused to slip may be selected in any pattern. In particular, in the case of selecting the friction engagement element to be caused to slip, the friction engagement element may be selected in any desired manner as long as the friction engagement element is not continuously caused to slip even when shifting is performed. For example, the friction engagement element may be randomly selected or a predetermined pattern may be set based on the acceptable heat capacity of the friction plates etc.

As described in the first to third embodiments, when the friction engagement element different from the friction engagement elements being in the engaged state is caused to slip by warm-up slip control while the shift speed is maintained, a breaking force is produced in the automatic transmission so as to decelerate the vehicle. At this time, a braking force larger than the amount by which the brake pedal is intentionally depressed by the driver may be generated. Accordingly, in vehicles that can change a braking force of the brake with respect to the amount by which the brake pedal is depressed, such as vehicles equipped with an anti-lock brake system, the braking force of the brake may be controlled to be reduced by an amount corresponding to the braking force of the automatic transmission so that the overall braking force of the vehicle is adjusted according to the driver's intension to decelerate the vehicle. For example, in vehicles having an engine as a driving source, pumping loss is caused in the engine so that engine brake is applied during deceleration of the vehicle. Accordingly, a throttle valve may be opened to reduce the pumping loss so that the overall braking force of the vehicle is adjusted according to the driver's intension to decelerate the vehicle. The braking force may be adjusted by any other means that can control the overall braking force of the vehicle so as to reduce the braking force generated in the automatic transmission with respect to the amount by which the brake pedal is depressed by the driver.

In the first to third embodiments, the engagement pressure of the friction engagement element to be caused to slip is reduced during shifting that is performed during warm-up slip control, so that hydraulic control during the shifting that is performed by changing the engagement states of the friction engagement elements is performed in a manner similar to that of the normal shift control. In this case, since the friction engagement element is caused to slip and a braking force is generated in the automatic transmission, this braking force may be eliminated during shifting, whereby the driver may feel discomfort. Accordingly, in the hydraulic control during shifting that is performed by changing the engagement states of the friction engagement elements, a decrease in engagement pressure of the friction engagement element to be disengaged may be delayed or the gradient of the decrease may be made gentler, or an increase in engagement pressure of the friction engagement element to be engaged may be advanced or the gradient of the increase may be made steeper. Namely, the hydraulic control during shifting that is performed by changing the engagement states of the friction engagement elements may be changed from the normal shift control so that a braking force corresponding to the braking force that is generated by causing the friction engagement element to slip in the warm-up slip control may also be generated during shifting.

### INDUSTRIAL APPLICABILITY

The automatic transmission of the present disclosure can be used as an automatic transmission that is mounted in vehicles such as passenger cars and trucks, and preferably used as an automatic transmission that is desired to be warmed up without hindering improvement in fuel economy.

1. An automatic transmission, comprising:
a speed change mechanism including a gear mechanism that can attain a plurality of shift speeds, and a plurality of friction engagement elements that are selectively engaged to attain each shift speed in the gear mechanism;
a hydraulic control device that can regulate engagement pressures to be supplied to hydraulic servos of the plurality of friction engagement elements and that can supply lubricating oil that lubricates the speed change mechanism; and
a control unit that sends a command about the engagement pressures to the hydraulic control device to control engagement states of the plurality of friction engagement elements, wherein
when a vehicle is in a non-driving state and a non-shifting state where the shift speed is maintained and an oil temperature is higher than a predetermined temperature, the control unit supplies an engagement pressure to a hydraulic servo of a friction engagement element being in an engaged state and maintaining the shift speed, and does not supply an oil pressure so as to disengage a different friction engagement element of the friction engagement elements, the different friction engagement element being different from the friction engagement element being in the engaged state, and
when the vehicle is in the non-driving state and the non-shifting state where the shift speed is maintained and the oil temperature is the predetermined temperature or less, the control unit supplies the engagement pressure to the hydraulic servo of the friction engagement element being in the engaged state and maintaining the shift speed, and supplies an oil pressure so that the different friction engagement element different from the friction engagement element being in the engaged state is in a slipping state.

2. The automatic transmission according to claim 1, wherein
the control unit determines in response to an operation of releasing an accelerator pedal that the vehicle is in the non-driving state.

3. The automatic transmission according to claim 2, wherein
the control unit determines in response to an operation of depressing a brake pedal that the vehicle is in the non-driving state.

4. The automatic transmission according to claim 3, wherein
the slipping state is a state where the fiction engagement element slightly transmits torque.

5. The automatic transmission according to claim 4, wherein
the non-shifting state is a state from completion of previous shifting to a subsequent speed change decision.

6. The automatic transmission according to claim 5, wherein
the control unit changes, for each shift operation, the friction engagement element to be caused to slip.

7. The automatic transmission according to claim 6, wherein
when causing the different friction engagement element to slip, the control unit causes the friction engagement element, which is expected to be engaged by subsequent downshifting according to a decrease in vehicle speed, to slip.

8. The automatic transmission according to claim 6, wherein
when causing the different friction engagement element to slip, the control unit causes the friction engagement element other than the friction engagement element that is to be engaged at the shift speed to be attained by upshifting to one speed higher or downshifting to one speed lower to slip out of the plurality of friction engagement elements.

9. The automatic transmission according to claim 6, wherein
when causing the different friction engagement element to slip, the control unit causes the friction engagement element engaged at the shift speed before shifting to slip.

10. The automatic transmission according to claim 7, wherein
the control unit allows the different friction engagement element to slip when deceleration of the vehicle is predetermined deceleration or less.

11. The automatic transmission according to claim 10, wherein
the control unit calculates an amount of heat that is generated by the friction engagement element to be caused to slip, and allows the different friction engagement element to slip when the calculated amount of heat is an acceptable amount or less.

12. The automatic transmission according to claim 11, wherein
the hydraulic control device can change an oil pressure of the lubricating oil that lubricates the speed change mechanism, and
when causing the different friction engagement element to slip, the control unit increases the oil pressure of the lubricating oil to a value higher than that before the friction engagement element is caused to slip.

13. The automatic transmission according to claim 12, wherein
when the vehicle is in the non-driving state and the non-shifting state where the shift speed is maintained and the oil temperature is in a very low temperature state, the control unit supplies the engagement pressure to the hydraulic servo of the friction engagement element being in the engaged state and maintaining the shift speed, and does not supply an oil pressure so as to disengage the different friction engagement element different from the friction engagement element being in the engaged state.

14. The automatic transmission according to claim 1, wherein
the control unit determines in response to an operation of depressing a brake pedal that the vehicle is in the non-driving state.

15. The automatic transmission according to claim 1, wherein
the slipping state is a state where the fiction engagement element slightly transmits torque.

16. The automatic transmission according to claim 1, wherein
the non-shifting state is a state from completion of previous shifting to a subsequent speed change decision.

17. The automatic transmission according to claim 1, wherein
the control unit changes, for each shift operation, the friction engagement element to be caused to slip.
